(19) United States
(12) Patent Application Publication
(10) Pub. No.: US 2015/0254349 A1
(43) Pub. Date: Sep. 10, 2015

(54) System and Method for Providing Content in Real-Time

(71) Applicant: Itai SELA, Raanana (IL)

(72) Inventor: Itai Sela, Raanana (IL)

(21) Appl. No.: 14/433,448

(22) PCT Filed: Sep. 17, 2013
(86) PCT No.: PCT/IL2013/050792

§ 371 Date: Apr. 3, 2015

(30) Foreign Application Priority Data
Oct. 11, 2012 (IL) 222405

(51) Int. Cl. G06F 17/30; G06F 3/0484; G09B 5/06

(52) U.S. Cl. CPC G06F 17/30864; G09B 5/06; G06F 17/3089; G06F 3/0484

(57) ABSTRACT

The present invention relates to a method for providing content in real-time while a user visits a webpage, comprising the steps of: a) establishing a user profile, wherein said user profile includes predefined content sources for extracting information relevant to the currently visited webpage; b) locating potential object(s) from content gleaned in real-time from webpage the user currently visits; c) identifying relevant content for the user by correlating the located potential keyword(s) or phrase(s), in relation to contextuality and statistics and/or to other general factors e.g. user's location, user's age, etc., with the pre-defined content sources of the user's profile; and d) providing/displaying the identified relevant content to the user via the user's terminal unit.

### FIELD OF THE INVENTION

The present invention relates to the field of content providing systems. More particularly, the invention relates to a computer network-enabled education system and method.

### BACKGROUND OF THE INVENTION

As more users are connected to the Internet and conduct their daily activities electronically, it is desired to take advantage of the time a user surfs the web, and to provide the user with educational content based on specific curriculum and other predefined values during that time.

Therefore, it is an object of the present invention to provide learning material in real-time to the user while the user surfs the web, in such a manner that the provided learning material is related to the content of the currently visited webpage.

It is another object of the present invention to provide a system which is capable of opening new channels of communication between parents and their children.

Other objects and advantages of the invention will become apparent as the description proceeds.

### SUMMARY OF THE INVENTION

The present invention relates to a method for providing content in real-time while a user visits a webpage, comprising the steps of:

a. establishing a user profile, wherein said user profile includes predefined content sources for extracting information relevant to the currently visited webpage;
b. locating potential object(s) from content gleaned in real-time from webpage the user currently visits;
c. identifying relevant content for the user by correlating the located potential keyword(s) or phrase(s), in relation to contextuality and statistics and/or to other general factors e.g. user's location, user's age, etc., with the predefined content sources of the user's profile; and
d. providing/displaying the identified relevant content to the user via the user's terminal unit.

According to an embodiment of the present invention the provided content is a learning material.

According to an embodiment of the present invention the potential objects are selected from the group consisting of: one or more characters, a text, an audible source (e.g., a song, one or more sounds, etc.), a video source, a digital image or any combination thereof.

According to an embodiment of the present invention the method further comprises a gaming plug-in for allowing obtaining potential keywords/natural phrases from a gaming source while the user plays a game at said gaming source.

In another aspect the invention relates to a computer-implemented method comprising:
a. analyzing a browsing pattern of a user at a website;
b. determining an area of interest using the analysis;
c. correlating the determined area of interest with a predetermined learning profile of said user and accordingly selecting alternative content sources which reflects the correlation; and
d. providing the one or more of said selected alternative content sources to the user.

According to an embodiment of the invention, the area of interest is at least one character, a text, an audible content, a video source, an image or any combination thereof.

In another aspect the invention relates to a system for providing content in real-time while a user visits a webpage, comprising: a) a terminal unit; b) a content tracker operative on the terminal unit to receive user activity at a website, the content tracker comprising: a behavior collector to analyze a browsing pattern from the user activity and determine an area of interest using the analysis; and c) a content selection server to correlate between a predefined learning profile of said user and the user activity at the website using the analysis.

### BRIEF DESCRIPTION OF THE DRAWINGS

In the drawings:

FIG. 1 is a block diagram generally illustrating an embodiment of the invention for providing learning material while surfing the web;

FIG. 2 schematically illustrates a content selection server of the system of FIG. 1;

FIG. 3 is a flow chart generally illustrating the method of the invention; and

FIGS. 4-7 schematically illustrate exemplary screenshots of real-time interaction and content providing between a user and an animated avatar, according to embodiments of the present invention.

### DETAILED DESCRIPTION OF THE INVENTION

Various embodiments are directed to providing content, such as curriculum related content, in real-time while the user visits a website, where the content is targeted according to the user's behavior within the website. Embodiments may include a mapping between the currently visited website to other suggested websites and/or specific sections within the visited website that include content that involves also content that is relevant or related the user's curriculum, but where the suggested websites still represent the user's intent. Embodiments may track a user's interactions with the website and estimate the user's intent from those interactions. The user's estimated intent may be mapped to a section of the user's curriculum. The system of the present invention may provide the estimated section, with a confidence factor and what subject matter the user was interested in, to a content selection service. The content selection service may suggest content to the user based on the user's curriculum and the subject matter.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Although the present invention is described with respect to an educational system, in which the users are school children or students. The system can be implemented as a commercial system that may suggest a specific commercial product to the user in real-time while the user visits a specific webpage and wherein the commercial product is related either directly or indirectly to the content of the webpage.

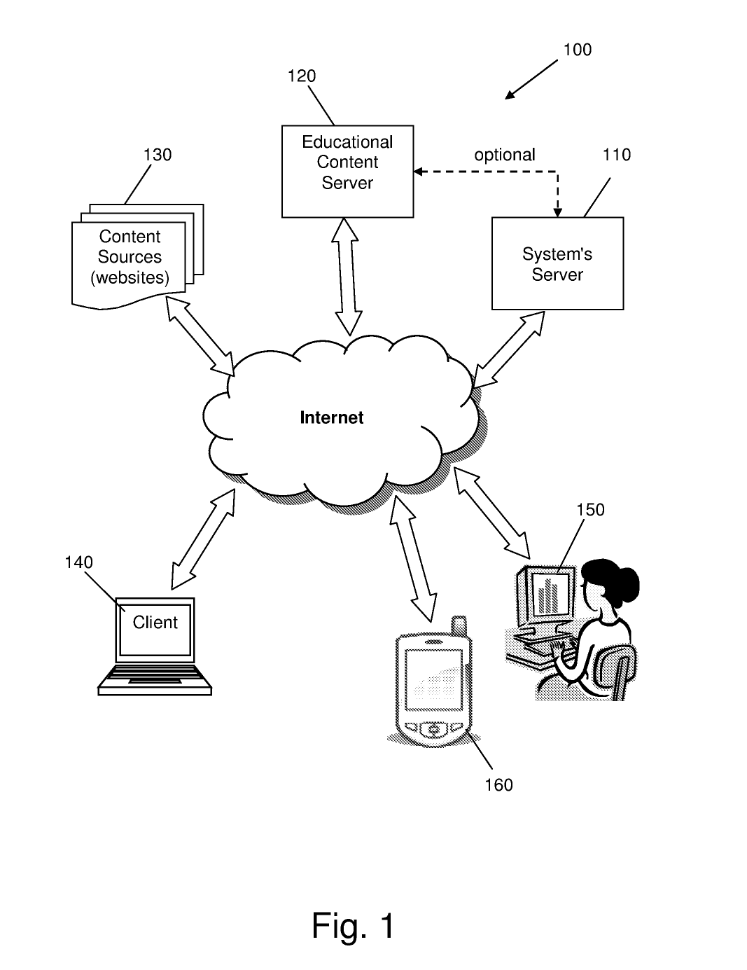

FIG. 1 illustrates a system 100 to provide targeted educational content based on an estimate of a user's intent from the user's behavior (in real-time while surfing the web). In one embodiment, for example, the system 100 may comprise a computer-implemented system having multiple components, such as a Content Selection Server (CSS) 110, an Educational Content Server (ECS) 120, a user's client application 140, a data interface 150 and a monitoring client application 160. The system's components can communicate with each other via the Internet, or directly as shown by the dotted arrow between the CSS 110 and the ECS 120.

As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The computing entities or devices of system 100 may be communicatively coupled via a network (e.g., the Internet), which may be implemented via various types of communications media, including wired or wireless communications media. The network may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of system 100 may include various types of standard communication elements designed to be interoperable with the network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of system 100 can be in the form of a data packet adapted to be transmitted between two or more computer processes. The data packet may include a cookie and/or associated contextual information, for example.

In an embodiment, system 100 includes the content selection server 110. CSS 110 may comprise a network server implementing a content analyzing module, a website hosting application, a web browser, or other suitable application for serving content to clients, such as client 140. A website may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof.

Content selection server 110 may serve a number of different web pages containing varied educational content with respect to current content that is view by the user. The educational content may include default content that is served to all users, or that is served in the absence of any additional information received or detected about a client's previous on-line activity. The content may also include a section that can be dynamically updated or loaded separately from the rest of the page, where the content for the section may come from educational content server 120 as will be described later. In some cases, the CSS 110 may be operated by an entity, such as an educational institute or school, or individual (e.g., the user's teachers or parents, as by numeral 150 and 160), and hosted primarily from one network address. There is a simple registration/set-up procedure which is performed by the individual (e.g., the user's teacher or parents) via the data interface 150 (e.g., via a corresponding application at his smart phone or a dedicated website interface via a personal computer, etc.), in which the user/teacher/parent feeds into the CCS 110 data representing the learning portfolio of the user in addition to the common required personal details of the user, such as, I.D. number, age, class, etc. The learning portfolio may include the user's curriculum, syllabus, list of relevant websites, links to relevant books that are stored in a digital form in the ECS 120 or within other content sources 130, or any other educational information.

A client application, such as client application 140, may serve a variety of types of content providing and interaction with a user, such as, without limitation, an animated avatar, chat either via internal chat application of the system or via third party application such as social networks (e.g., Facebook), a gaming like form, a user forum site, and other interfaces aggregating a certain type or genre of information.

According to some embodiments of the present invention, the client application 140 (e.g., via an interface in form of an animated avatar) may operate in three different levels:
A social level—the system allows the user to chat with other users, ask questions and in response to get answers (through the animated avatar) from selected network sources such as the ECS 120, the content sources 130, Rich Site Summary (RSS) feeds, and the like. The system may also interact with a user calendar in order to present (e.g., via the animated avatar) reminders or other relevant diary based information to the user;
An area of interest level—the system allows the user to select content according to user's own interests (e.g., sports, art, fashion, etc.). In this level the information can be obtained from different content sources such as content sources 130;
A learning portfolio level—deals with the user's official studies program, as described herein in further details with respect to CCS 110.

Using these levels simultaneously, allows learning, which combines two or three levels together, and thus deepens the experience of learning and enables a depth learning that is based on the passion and interests of the user.

According to an embodiment of the invention, the client application 140 (e.g., via the avatar) allows users to create their own content for their own records or for sharing with others, on each level (either separately or in combination of two or more levels). In order to share the own created content with others (so called the wisdom of crowds), the created content might be further transferred for approval by a group of users (e.g., professional community) in the specific field and/or by the system. Such a process is a significant educational concept which allows users to learn through the process of own creating content. The approved own created content can be added to the CSS 110 or can be stored in other database related to the system, such as content sources 130.

CSS 110 may serve one or more kinds of educational related content to the user via the client 140. For example, CSS 110 may serve educational information, news, multimedia content, entertainment content, etc. The content may be served as links to a number of webpages. Each webpage suggested by CSS 110 may also be associated with an educational service, an educational topic, a curriculum, or other characteristics that identify aspects of the webpage that can be used in correlation with the currently content viewed by the user.

CSS 110 may include a real-time content tracker to analyze user behavior while browsing a website. User behavior may include interactions between user's client 140 and a visited website, such as, but not limited to, web pages loaded on user's browser, search strings entered from user's browser, forms filled out, etc. Content tracker may examine the data about the pages that a user has viewed. Content tracker may aggregate and/or analyze, for example, the page types, categories, and/or content associated with the pages that a user has viewed. Content tracker may further collect and/or analyze information to determine the subject matter that a user is interested in, for example, a type of product, a service, a news item, a sports team, a hobby, and so forth.

Client application 140 is configured to be executed on a wired or wireless computing device operating a browser, or to interact with an application viewer or other application program suitable for receiving and displaying content served by content sources 130 (e.g., a webpage). Client 140 may receive and respond to control directives from a user, for example, input from an input device that causes the browser to connect to a specific website, fill out a form, follow a hyperlink, play a multimedia content (e.g., an audio stream or a video stream) and so forth. Client 140 may forward to the CSS 110 information about the user's activity online and in real-time. For example, CSS may analyze the content being viewed by the user while the user visits a specific website (whether it is a text, an audio or a video), in order to suggest that user (via the client 140) an alternative content(s) that is related both to the currently visited webpage and to the user's curriculum.

Client 140 may also keep a record of input commands received from a user, output presented on a display for the user, and any other information that may assist in predicting or identifying the user's activity online. Additionally or alternatively, another network device may record information about the user's behavior online, such as the CSS 110, for example. The embodiments are not limited to these examples.

In an embodiment, system 100 may include the Educational Content Server (ECS) 120. ECS 120 may be in communication with CSS 110. ECS 120 may provide information about the user, such as user's curriculum, educational subject matter of interest, etc. The information may be provided as one or more separate values, or may be provided as a bin identifier where the bin corresponds to the subject matter of interest. ECS 120 may use the received information to select content to be inserted into the content served by CSS 110 and displayed to client 140. ECS 120 may provide the selected content to CSS 110. The selected content may then be processed and inserted into the content served by CSS 110 and displayed to client 140, or presented separately from the content served by the CSS 110, such as in a separate graphical user interface (GUI) view or web page. The embodiments are not limited in this context.

In an embodiment, ECS 120 may store and provide content to CSS 110 without being accessible independently of CSS 110. ECS 120 may store and provide content from a plurality of independent sources and select, as a service, which content to provide to CSS 110 based on the estimated user's intent and area of interest received from CSS 110.

ECS 120 may be operated by the same entity as for CSS 110, or may be independent. In general, the entity or entities that provide content via ECS 120 (e.g., the user's teacher) desire to display their content to a more specific audience. Therefore, in an embodiment, ECS 120 may specify the categories of users that it can target. The target audiences may be grouped into segments, such as the bins referred to previously. A segment may represent, for example, demographic (e.g., 5^{th} grade pupils); an interest category (e.g. physics, astronomy); and so forth. The embodiments are not limited in this context.

In general, ECS 120 may store content to supplement content provided by the CSS 110 (via other content sources 130, such as specific websites). The content of CSS 110 and of ECS 120 may comprise any multimedia information, including an animated avatar, text, audio, video, images, pictures, graphics, icons, and so forth. In an embodiment, ECS 120 may provide content that is related in some way to content provided by client 140. The content provided may also be related to the intent of the user, as estimated from the user's behavior. For example, when a user has viewed a number of pages for different models of a particular product (e.g., a digital camera), CSS 110 may serve content related to independent information, such as a physical phenomena about the product that the user has viewed (e.g., that is related to the functionality of a digital camera). When a user appears interested in a specific content, CSS 110 may provide relevant educational content (via client application 140), such as in a dialogue form with an animated avatar, chat, or other events related to the content of interest to the user. Additionally, the user may “ask” the client application 140 (e.g., via a common search tool) to provide information regarding specific topic. The embodiments are not limited to these examples.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a Personal Computer (PC) system or data device, other computer or electronic systems can be used as well, such as, without limitation, a tablet, an interactive television, a network-enabled personal digital assistant (PDA), a network game console, a networked entertainment device, a smart phone (e.g., with an operating system and on which a user can install applications) and so on.

In addition, while certain user inputs or gestures are described as being provided via phone key presses, data entry via a keyboard, or by clicking a computer mouse or button, optionally, user inputs can be provided using other techniques, such as by voice or otherwise. The example screen layouts, appearance, and terminology as depicted and described herein, are intended to be illustrative and exemplary, and in no way limit the scope of the invention as claimed.

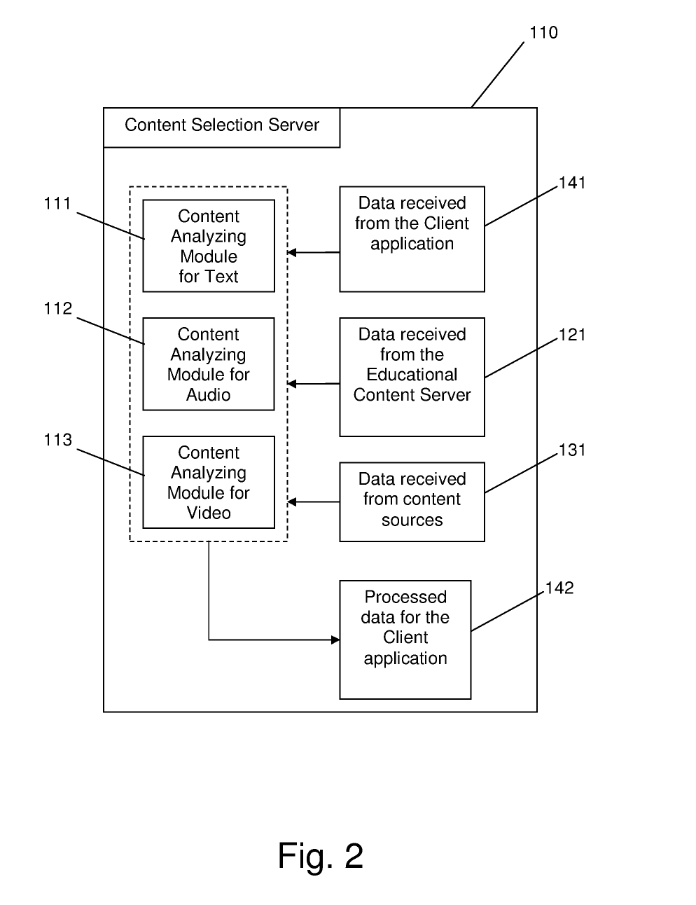

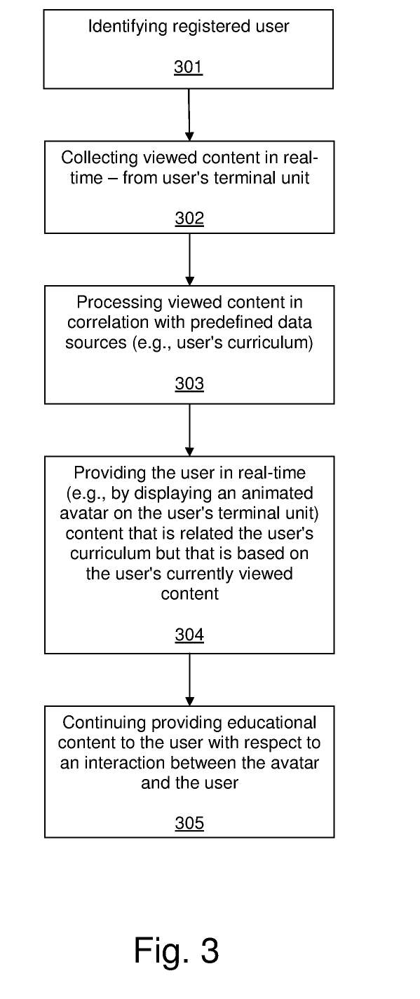

FIG. 2 illustrates a block diagram of a CSS 110 to provide targeted content based on an estimate of a user's intent from the user's behavior while the user browsing the web in real-time. The targeted content can be provided either automatically by the system or on-demand by the user. CSS 110 comprises one or more Content Analyzing Module (CAM) for text, audio or video sources (as indicated by numeral 111, 112 and 113, respectively). The CAM may collect information about user intent online and in real-time. In general, user intent may refer to an area of interest. Information about user intent may include, for example, data about the pages involved in user's computer activity. The activity may refer to control directives received at client 140 (e.g., from a user that cause client 140 to request and receive content from the user's browser). The control directives may include, for example, selecting a hyperlink with an input device, typing a search string into a search interface, typing a URL into a browser. The data about the pages may include page types, categories, topics, and so forth. In this figure, data received from the client application is indicated by numeral 141, data received from the Educational Content Server 120 is indicated by numeral 121, data received from content sources 130 is indicated by numeral 131 and processed data that is returned to the client application is indicated by numeral 142.

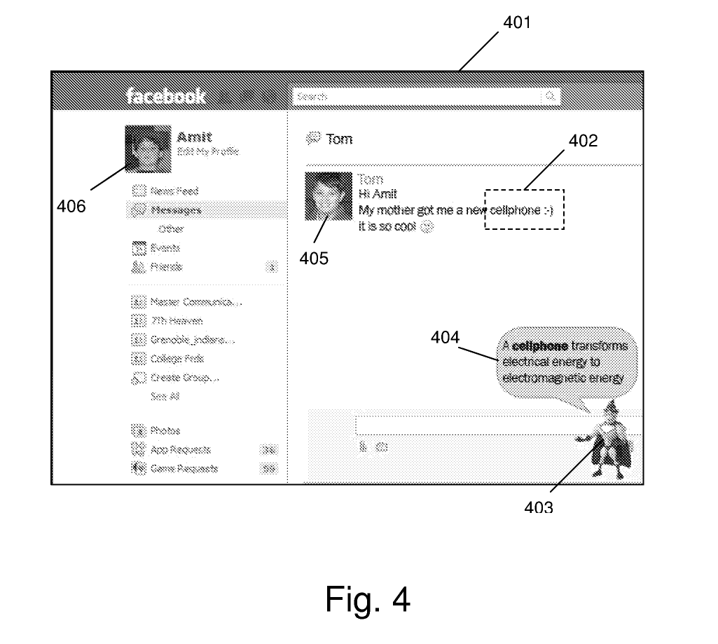

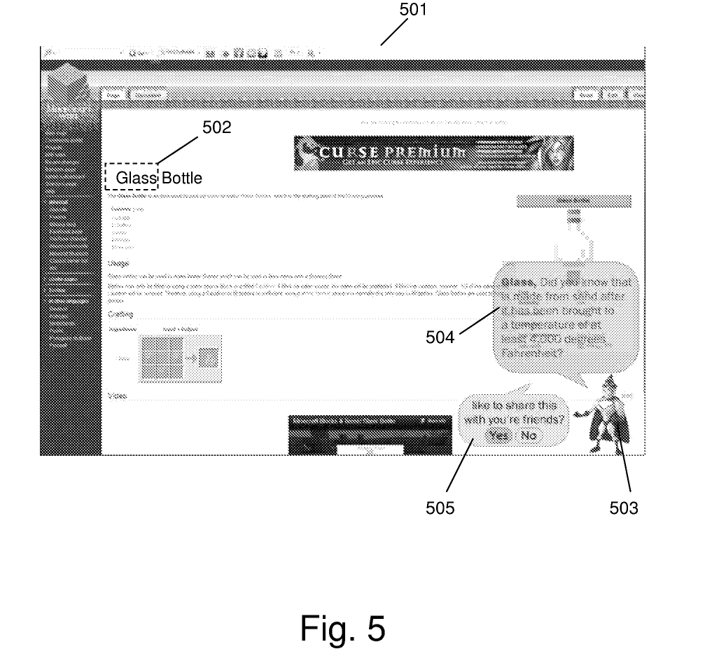

According to an embodiment of the invention, the CAM for text 111 is adapted to perform a content/textual analysis of the webpage content (or other sources). As known to the skilled person, content analysis can involve any kind of analysis where communication content (speech, written text, interviews, images, etc.) is categorized and classified. For example, the cam searches for keywords in the webpage that appear in the data stored in the educational content server 120 or on other pre-defined content sources 130. In such case, the relevant sentence from a given content source, e.g., content within a book (that is stored in a textual form in the educational content server 120) that matches the keyword in the currently analyzed webpage, is extracted from the content source and provided in real-time for the user by the client 140. For example, the content analysis can be based on one or more specific keywords as described in greater details with respect to FIGS. 4 and 5 hereinafter. In addition, other methods of textual analysis may be applied as well. These methods include Natural Language Processing (NLP) which enables the analysis of phrases (as opposed to keywords). Also, contextual analysis may be applied, which allows categorization of textual input according to the context. This method is frequently applied based on statistics and ever-growing knowledge base, i.e. a learning system.

According to an embodiment of the present invention, the textual analysis can be done on a full webpage. In such case, the CSS 110 may process the full page context to match educational content with user interests. Alternatively, only a selected area within the webpage can analyzed such as titles, subtitles, the text within the regions where the pointing device's cursor is currently positioned on the webpage, etc.

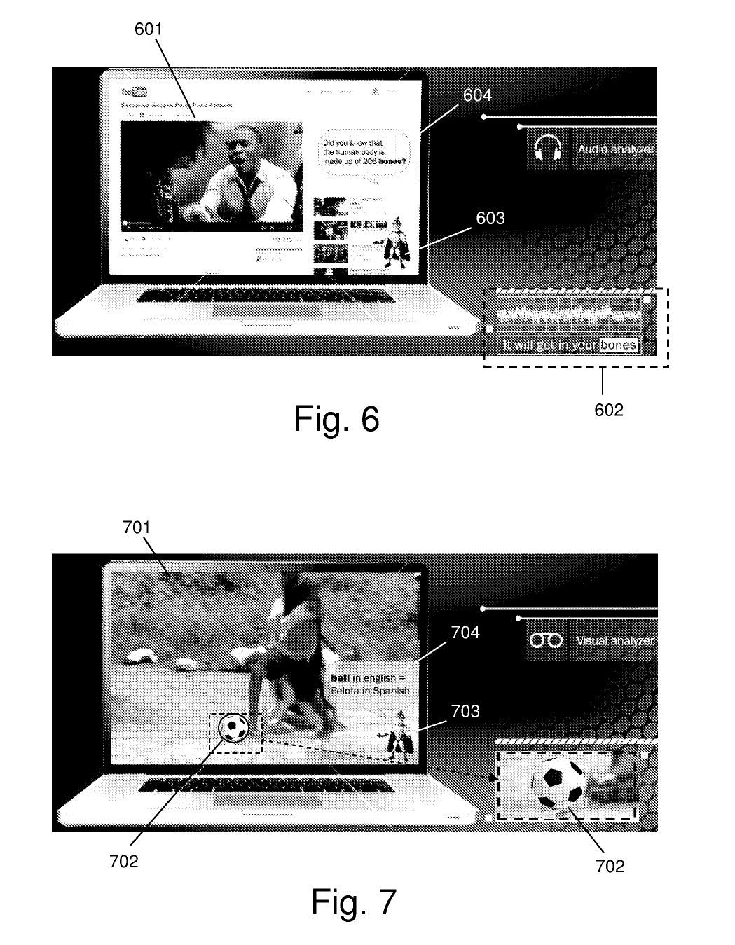

According to an embodiment of the invention, the CAM for video 112 may implement standard approaches to various signal processing tasks as required for audio information retrieval systems. As appreciated by the skilled person an audio source can be categorized into four classes (tonal, temporal, timbral, and intensity-related). There are several ways to extract characteristics for each individual category, for instance, fundamental frequency, tempo, timbre features, and audio level. Alternatively, a speech to text engine (not shown) can be used in order to convert the audio data into text representation. FIG. 6 schematically illustrates an audio analysis on a played content 601 via “YouTube”, according to an embodiment of the present invention. The CAM 112 analyzes the audio stream (indicated by numeral 602) from the currently played content 601 (e.g., using a common speech-to-text module and then a text analysis similar as described with respect to CAM 111 hereinabove).

In this example, the word “bone” is detected and found relevant to a learning topic that is stored in the educational content server 120. As a result, the relevant sentence (e.g., “did you know that the human body is made up of 206 bones”) from the stored content source (e.g., a given book on anatomy) is extracted and provided by the client 140 in form of an avatar 603 through a callout 604.

According to an embodiment of the invention, the CAM for video 113 is adapted to automatically analyzing video to detect and determine temporal events not based on a single image. This technical capability is used in a wide range of domains including entertainment, health-care, retail, automotive, transport, etc. As will be appreciated by a skilled person, the algorithms can be implemented in the CSS 110 as software, or as hardware in specialized video processing units. For example, FIG. 7 schematically illustrates a video analysis on a played content 701, according to an embodiment of the present invention. The CAM 113 analyzes the video stream and identifies objects within the video's frames. In this example, the CAM 113 identified a ball 702. As a result, CSS 110 provides the client 140 (in form of avatar 703) with information relevant to the identified ball 702. In this case the information relates to languages and the callout 704 displays the following text: “ball in English=pelota in Spanish”.

According to an embodiment of the present invention, the system comprises software means that are capable of analyzing content from games sources (not shown). For example, the client 140 may include a dedicated plug-in that allows it to integrate with on-line web based games in order to extract relevant contextual information while the user plays a specific game. Thereby providing the user (during the game) an educational content (e.g., by the avatar as shown and described with respect to FIGS. 4-7 and the CAM 111-113).

In an embodiment, client application 140 includes a content tracker that may receive information, for example, about the pages and/or page types visited by the user, products associated with the visited pages, search strings entered, and other information, from the user's computer. The CAM may use the information from the client 140 to estimate the user intent, determine the content of interest and calculate the confidence measure. Alternatively, client 140 may provide these values to the CAM, which may compare the values against a set of rules or steps to arrive at a segment when a rule is matched or a series of steps is complete in order to classify the user's intent into one or more segments, including bins representing areas of interest. CSS 110 may use the segment to select content to insert into the content served by client 140 and displayed to the user.

In an embodiment, the CAM (such as CAM 111, 112, 113 or any combination thereof) may be invoked when a user's computer system, such as a user's PC, initiates a connection to a website, for example, by requesting and loading a web page from a browser. In an embodiment, the CAM may be invoked from client 140 when the user's computer begins loading the web page. The web page may contain a script, such as a Javascript, that runs when the client loads the web page. The script may invoke the client 140.

An additional advantage provided by the invention is the ability of the user's parents or teacher to monitor the user's activity while surfing the web. According to an embodiment of the invention, a monitoring client application 160 (in FIG. 1) may be executed on the parent's mobile device (e.g., a smart phone) through which the parent can receive from the CSS 110, in real-time, information regarding the user's behavior on the web, content of interest, and the like. Optionally, the monitoring application 160 allows to the parent to interact with the user through the client application 140, if required.

Turning now to the computer architecture, in accordance with one or more embodiments, that is suitable for implementing various embodiments as previously described. The computing architecture may include various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by any computing architecture. For example, the computing architecture (not shown) comprises logic device(s), a system memory and a system bus. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s). The system bus provides an interface for system components including, but not limited to, the system memory to the logic device(s). The system bus can be any of several types of bus structure that may further interconnect to a memory bus (with or without a memory controller), a peripheral bus, and a local bus using any of a variety of commercially available bus architectures.

The computer may include various types of computer-readable storage media, including an internal hard disk drive (HDD), a magnetic floppy disk drive (FDD) to read from or write to a removable magnetic disk, and an optical disk drive to read from or write to a removable optical disk (e.g., a CD-ROM or DVD). The HDD interface for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units including an operating system, one or more application programs, other program modules, and program data. The one or more application programs, other program modules, and program data can include, for example, behavior collector, position estimator, confidence calculator and page map.

A user can enter commands and information into the computer through one or more wire/wireless input devices, for example, a keyboard and a pointing device, such as a mouse. Other input devices may include a microphone, an infra-red (IR) remote control, a joystick, a game pad, a stylus pen, touch screen, or the like. These and other input devices are often connected to the logic device(s) through an input device interface that is coupled to the system bus, but can be connected by other interfaces such as a parallel port, IEEE 1394 serial port, a game port, a USB port, an IR interface, and so forth.

A monitor or other type of display device is also connected to the system bus via an interface, such as a video adaptor. In addition to the monitor, a computer typically includes other peripheral output devices, such as speakers, printers, and so forth.

The computer may operate in a networked environment using logical connections via wire and/or wireless communications to one or more remote computers, such as a remote computer. The remote computer can be a workstation, a server computer, a router, a personal computer, portable computer, microprocessor-based entertainment appliance, a peer device or other common network node, and typically includes many or all of the elements described relative to the computer. The logical connections depicted include wire/wireless connectivity to a local area network (LAN) and/or larger networks, for example, a wide area network (WAN). Such LAN and WAN networking environments are commonplace in offices and companies, and facilitate enterprise-wide computer networks, such as intranets, all of which may connect to a global communications network, for example, the Internet.

All the above will be better understood through the following illustrative and non-limitative examples.

FIG. 4 schematically illustrates an exemplary screenshot of a “Facebook” chat session 401 between two users named Tom and Amit (as indicated by numerals 405 and 406 respectively). During this chat session the user Tom wrote the following sentence: “Hi Amit, my mother got me a new cellphone :-) it is so cool [symbol] ”. The system (via the client, such as client 140 of FIG. 1) analyzes the content of the chat session and correlates it with the user's curriculum (or other predefined content sources). In this example, after this processing stage, the system found that the term “cellphone” (as indicated by numeral 402) is related to currently curriculum of the user Tom 405 in the field of physics (e.g., electrical energy). As a result, the system's client (e.g., in form of an animated avatar 403) “pop-up” and provide the user Tom 405 with educational information that is related to the term “cellphone” (e.g., as indicated by the text within the callout 404 that says: “A cellphone transforms electrical energy to electromagnetic energy”).

FIG. 5 schematically illustrates an exemplary screenshot of a typical webpage 501. In this example, the content of the webpage is about glass bottles. The system (via the client, such as client 140 of FIG. 1) analyzes the content of the webpage 501 and correlates it with the user's curriculum (or other predefined content sources). In this example, after the processing stage, the system found that the term “glass” (as indicated by numeral 502) is related to the curriculum of the user in the field of physics. As a result, the system's client (e.g., in form of an animated avatar 503) “pop-up” and provide the user with educational information that is related to the term “glass” (e.g., as indicated by the text within the callout 504 that says: “Glass, Did you know that is made from sand after it has been brought to a temperature of at least 4000 degrees Fahrenheit?”).

Additionally, the system may provide to the user (via the avatar 503) the option the share the information provided by the callout 504 with other users as indicated by the callout 505. As will be appreciated by the skilled person, this can be done by the system's server CSS 110 either via a dedicated social network of the system's users or alternatively via an integration with common social network, such as Facebook.

The avatar such as the one indicated by numerals 403 and 503 can be the graphical representation of the user or the user's alter ego or character. It may take either a three-dimensional form, as in games or virtual worlds, or a two-dimensional form as an icon in Internet forums and other online communities. The character of the animated avatar can be provided by the system of the present invention, or it can be selected or custom made by the user using dedicated software tools the can be provided by the system's server CSS 110.

According to an embodiment of the present invention, the client may operate on the user's terminal unit (e.g., the user's PC) while offline (e.g., in case no Internet connection is available). In such case, the system may install in the client's terminal unit one or more content sources. For example, when the user reads a word document, the client may pop-up a callout with information regarding one or more of the terms within the word document.

The terms, “for example”, “e.g.”, “optionally”, as used hereinabove, are intended to be used to introduce non-limiting examples. While certain references are made to certain example system components or services, other components and services can be used as well and/or the example components can be combined into fewer components and/or divided into further components.

As will be appreciated by the skilled person the arrangement described in the figures results in a system and method for providing learning material in real-time while surfing the web, without interrupting the user, but in a friendly and fun manner. Moreover, the present invention opens new channels of communication between parents/teacher and their children.

All the above description and examples have been given for the purpose of illustration and are not intended to limit the invention in any way. Many different mechanisms, methods of analysis, electronic and logical elements can be employed, all without exceeding the scope of the invention.

1. A method of providing content in real-time while a user visits a webpage, comprising the steps of:
a. establishing a user profile, wherein said user profile includes predefined content sources for extracting information relevant to the currently visited webpage;
b. locating potential object(s) from content gleaned in real-time from webpage the user currently visits, by a client application;
c. identifying relevant content for the user by correlating the located potential object(s) with the predefined content sources of the user's profile; and
d. providing/displaying the identified relevant content via a user interface.

2. A method according to claim 1, wherein the provided content is a learning material.

3. A method according to claim 1, wherein the potential objects are selected from the group consisting of: one or more characters, a text, an audible source, a video source, a digital image or any combination thereof.

4. A method according to claim 1, wherein the potential objects are keyword(s) or phrase(s), in relation to contextuality and statistics and/or to other general factors, in particular user's location and user's age.

5. A method according to claim 1, further comprises a gaming plug-in for allowing to obtain potential keywords and/or phrases from a gaming source while the user plays an on-line game.

6. A method according to claim 1, wherein the user interface is an animated avatar.

7. A method according to claim 1, wherein the client application operates in three different levels: a social level, an area of interest level and a learning portfolio level, wherein using these levels simultaneously, allows learning, which combines two or three levels together, and thus deepens the experience of learning and enables a depth learning that is based on the passion and interests of the user.

8. A method according to claim 1, further comprising allowing users to create their own content for their own records or for sharing with others.

9. A method according to claim 8, wherein the own created content is stored in the content sources after being approved.

10. A computer-implemented method comprising:
a. analyzing a browsing pattern of a user at a website;
b. determining an area of interest using the analysis;
c. correlating the determined area of interest with a predetermined learning profile of said user and accordingly selecting alternative content sources which reflects the correlation; and
d. providing the one or more of said selected alternative content sources to the user.

11. A computer-implemented method according to claim 10, wherein the area of interest is one or more characters, a text, an audible content, a video source, an image or any combination thereof.

12. An system of providing content in real-time while a user visits a webpage, comprising: a) a terminal unit; b) a content tracker operative on the terminal unit to receive user activity at a website, the content tracker comprising: a behavior collector to analyze a browsing pattern from the user activity and determine an area of interest using the analysis; and c) a content selection server to correlate between a predefined learning profile of said user and the user activity at the website using the analysis.
